(19) United States
(12) Patent Application Publication
(10) Pub. No.: US 2023/0205671 A1
(43) Pub. Date: Jun. 29, 2023

(54) MULTIPATH DIAGNOSTICS FOR KERNEL CRASH ANALYSIS VIA SMART NETWORK INTERFACE CONTROLLER

(71) Applicant: Dell Products L.P., Round Rock, TX (US)

(72) Inventors: Kai ZHOU, Shanghai (CN); Zhuo ZHANG, Shanghai (CN)

(73) Assignee: Dell Products L.P., Round Rock, TX (US)

(21) Appl. No.: 17/578,983

(22) Filed: Jan. 19, 2022

(30) Foreign Application Priority Data
Dec. 23, 2021 (CN) 202111593322.8

(51) Int. Cl. G06F 11/36; G06F 11/30; G06F 11/32; G06F 11/07

(52) U.S. Cl. CPC G06F 11/3656; G06F 11/3034; G06F 11/301; G06F 11/328; G06F 11/0778

(57) ABSTRACT

An information handling system may include a host information handling system comprising at least one host processor and a network interface that includes an on-board storage. The network interface may be configured to enable remote debugging of a crash associated with the host information handling system by: exposing the on-board storage to the host information handling system as a virtual storage resource; receiving, from the host information handling system, a core dump file associated with the crash; and allowing access to the core dump file from a remote information handling system.

### TECHNICAL FIELD

The present disclosure relates in general to information handling systems, and more particularly to methods and systems for analyzing diagnostic information via a smart network interface controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In some computing applications, an information handling system may include a hypervisor for hosting one or more virtual resources such as virtual machines (VMs). A hypervisor may comprise software and/or firmware generally operable to allow multiple virtual machines and/or operating systems to run on a single information handling system at the same time. This operability is generally allowed via virtualization, a technique for hiding the physical characteristics of computing system resources (e.g., physical hardware of the computing system) from the way in which other systems, applications, or end users interact with those resources. Thus, a virtual machine may comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In other applications, an information handling system may be used in a “bare metal” configuration in which only one operating system is installed, and the hypervisor and virtual resources are not needed.

In either scenario, a network interface of the information handling system may comprise a smart network interface card or “SmartNIC” and/or a data processing unit (DPU), which may offer capabilities not found in traditional NICs. For purposes of this disclosure, the terms “SmartNIC” and “DPU” may be used interchangeably.

Various errors may occur in the execution of operating system (OS) code, application code, or other code (e.g., kernel panics, etc.). When a core dump (also referred to herein as a crash dump or a memory dump) is triggered by the OS kernel in response to a crash, data is saved for further processing and analysis. The important real-time state of the system, which may include data such as the program counter and stack pointer register values, memory management information, and other processor and OS flags and information, are saved into such core dump files. By default, such core dump files are typically stored at a local storage resource such as a hard drive. For purposes of this disclosure, the term “core dump file” refers to information including any or all of the following components: state information relating to a thread or process, stack information, heap information, register values, memory contents, flags, information regarding the reason for a crash, and information regarding system hardware and/or software.

Thus in order to perform local analysis of such core dump files, the OS typically must first be rebooted. However, rebooting the OS can destroy additional information about the environment that may not have been saved in the core dump file. For example, memory contents may not always be saved in a core dump file. Further, temporary files stored by the OS may be wiped out upon reboot. Thus a reboot may preclude a user from fully analyzing such information, which can be important in certain types of crashes.

Accordingly, embodiments of this disclosure may leverage the functionality of a SmartNIC to provide additional capabilities for core dump analysis.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with analysis of core dump information within an information handling system may be reduced or eliminated.

In accordance with embodiments of the present disclosure, an information handling system may include a host information handling system comprising at least one host processor and a network interface that includes an on-board storage. The network interface may be configured to enable remote debugging of a crash associated with the host information handling system by: exposing the on-board storage to the host information handling system as a virtual storage resource; receiving, from the host information handling system, a core dump file associated with the crash; and allowing access to the core dump file from a remote information handling system.

In accordance with these and other embodiments of the present disclosure, a method may include, in an information handling system that includes a host information handling system and a network interface that includes an on-board storage: the network interface enabling remote debugging of a crash associated with the host information handling system by: exposing the on-board storage to the host information handling system as a virtual storage resource; receiving, from the host information handling system, a core dump file associated with the crash; and allowing access to the core dump file from a remote information handling system.

In accordance with these and other embodiments of the present disclosure, an article of manufacture may include a non-transitory, computer-readable medium having instructions thereon that are executable by a processor of an information handling system including a host information handling system and a network interface that includes an on-board storage for: the network interface enabling remote debugging of a crash associated with the host information handling system by: exposing the on-board storage to the host information handling system as a virtual storage resource; receiving, from the host information handling system, a core dump file associated with the crash; and allowing access to the core dump file from a remote information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates a block diagram of an example architecture, in accordance with embodiments of the present disclosure.

### DETAILED DESCRIPTION

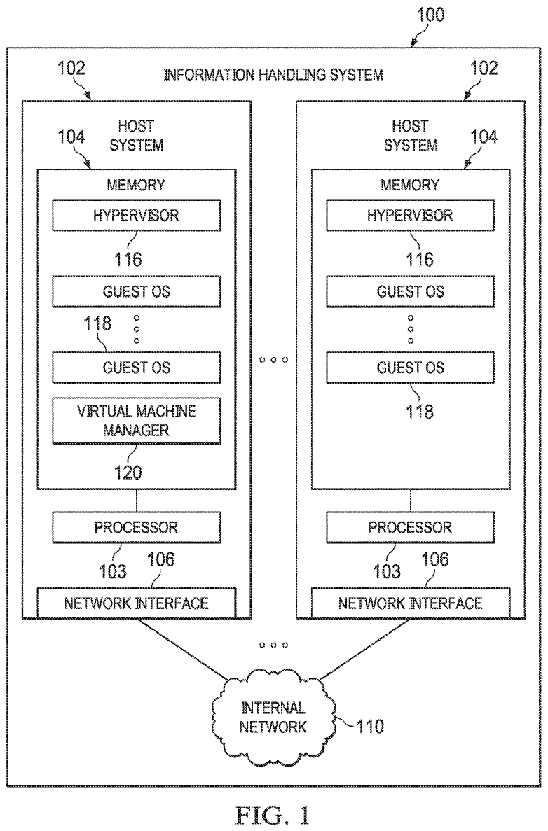

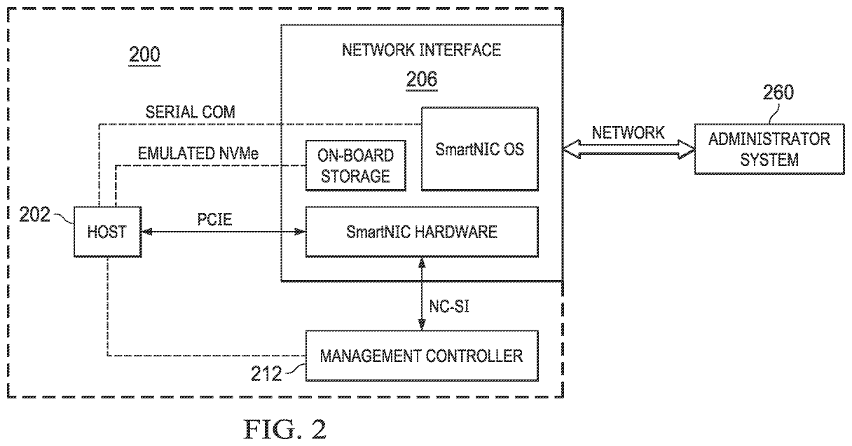

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing. Physical computer-readable media such as disk drives, solid-state drives, non-volatile memory, etc. may also be referred to herein as “physical storage resources.”

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of selected components of an example information handling system 100 having a plurality of host systems 102, in accordance with embodiments of the present disclosure. As shown in FIG. 1, information handling system 100 may include a plurality of host systems 102 coupled to one another via an internal network 110.

In some embodiments, information handling system 100 may include a single chassis housing a plurality of host systems 102. In other embodiments, information handling system 100 may include a cluster of multiple chassis, each with one or more host systems 102. In yet other embodiments, host systems 102 may be entirely separate information handling systems, and they may be coupled together via an internal network or an external network such as the Internet.

In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, information handling system 100 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to information handling system 100 is turned off.

As shown in FIG. 1, a memory 104 may have stored thereon a hypervisor 116 and one or more guest operating systems (OS) 118. In some embodiments, hypervisor 116 and one or more of guest OSes 118 may be stored in a computer-readable medium (e.g., a local or remote hard disk drive) other than a memory 104 which is accessible to processor 103. Each guest OS 118 may also be referred to as a “virtual machine.”

A hypervisor 116 may comprise software and/or firmware generally operable to allow multiple virtual machines and/or operating systems to run on a single computing system (e.g., an information handling system 100) at the same time. This operability is generally allowed via virtualization, a technique for hiding the physical characteristics of computing system resources (e.g., physical hardware of the computing system) from the way in which other systems, applications, or end users interact with those resources. A hypervisor 116 may be one of a variety of proprietary and/or commercially available virtualization platforms, including without limitation, VIRTUALLOGIX VLX FOR EMBEDDED SYSTEMS, IBM's Z/VM, XEN, ORACLE VM, VMWARE's ESX SERVER, L4 MICROKERNEL, TRANGO, MICROSOFT's HYPER-V, SUN's LOGICAL DOMAINS, HITACHI's VIRTAGE, KVM, VMWARE SERVER, VMWARE WORKSTATION, VMWARE FUSION, QEMU, MICROSOFT's VIRTUAL PC and VIRTUAL SERVER, INNOTEK's VIRTUALBOX, and SWSOFT's PARALLELS WORKSTATION and PARALLELS DESKTOP.

In one embodiment, a hypervisor 116 may comprise a specially-designed OS with native virtualization capabilities. In another embodiment, a hypervisor 116 may comprise a standard OS with an incorporated virtualization component for performing virtualization.

In another embodiment, a hypervisor 116 may comprise a standard OS running alongside a separate virtualization application. In this embodiment, the virtualization application of the hypervisor 116 may be an application running above the OS and interacting with computing system resources only through the OS. Alternatively, the virtualization application of a hypervisor 116 may, on some levels, interact indirectly with computing system resources via the OS, and, on other levels, interact directly with computing system resources (e.g., similar to the way the OS interacts directly with computing system resources, or as firmware running on computing system resources). As a further alternative, the virtualization application of a hypervisor 116 may, on all levels, interact directly with computing system resources (e.g., similar to the way the OS interacts directly with computing system resources, or as firmware running on computing system resources) without utilizing the OS, although still interacting with the OS to coordinate use of computing system resources.

As stated above, a hypervisor 116 may instantiate one or more virtual machines. A virtual machine may comprise any program of executable instructions, or aggregation of programs of executable instructions, configured to execute a guest OS 118 in order to act through or in connection with a hypervisor 116 to manage and/or control the allocation and usage of hardware resources such as memory, CPU time, disk space, and input and output devices, and provide an interface between such hardware resources and application programs hosted by the guest OS 118. In some embodiments, a guest OS 118 may be a general-purpose OS such as WINDOWS or LINUX, for example. In other embodiments, a guest OS 118 may comprise a specific- and/or limited-purpose OS, configured so as to perform application-specific functionality (e.g., persistent storage).

At least one host system 102 in information handling system 100 may have stored within its memory 104 a virtual machine manager 120. A virtual machine manager 120 may comprise software and/or firmware generally operable to manage individual hypervisors 116 and the guest OSes 118 instantiated on each hypervisor 116, including controlling migration of guest OSes 118 between hypervisors 116. Although FIG. 1 shows virtual machine manager 120 instantiated on a host system 102 on which a hypervisor 116 is also instantiated, in some embodiments virtual machine manager 120 may be instantiated on a dedicated host system 102 within information handling system 100, or a host system 102 of another information handling system 100.

A network interface 106 may include any suitable system, apparatus, or device operable to serve as an interface between an associated information handling system 100 and internal network 110. A network interface 106 may enable its associated information handling system 100 to communicate with internal network 110 using any suitable transmission protocol (e.g., TCP/IP) and/or standard (e.g., IEEE 802.11, Wi-Fi). In certain embodiments, a network interface 106 may include a physical network interface card (NIC). In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable NICs, including without limitation, mezzanine cards, network daughter cards, etc.

In some embodiments, a network interface 106 may comprise a SmartNIC and/or a DPU. In addition to the stateful and custom offloads a SmartNIC or DPU may provide, it may have an independent management domain with a separate operating system, independent credentials, and independent remote access. Accordingly, network interface 106 may include its own specialized processor and memory.

In addition to processor 103, memory 104, and network interface 106, a host system 102 may include one or more other information handling resources.

Internal network 110 may be a network and/or fabric configured to communicatively couple information handling systems to each other. In certain embodiments, internal network 110 may include a communication infrastructure, which provides physical connections, and a management layer, which organizes the physical connections of host systems 102 and other devices coupled to internal network 110. Internal network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Internal network 110 may transmit data using any storage and/or communication protocol, including without limitation, Fibre Channel, Fibre Channel over Ethernet (FCoE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

Turning now to FIG. 2, a block diagram of selected components of an information handling system 200 is shown, according to some embodiments. Information handling system 200 may include host 202. Host 202 may include or be communicatively coupled to network interface 206, which may be a SmartNIC. Network interface 206 may include various specialized elements such as processors, memory, etc., referred to generally as SmartNIC hardware. Network interface 206 may also include on-board storage and a SmartNIC OS as shown.

Network interface 206 may be coupled to host 202 via a Peripheral Component Interconnect Express (PCIe) interface. Additional communication pathways may also be present as well, in some embodiments. For example, network interface 206 may implement a serial COM port. In some embodiments, the serial COM port may be coupled to host 202 via a separate cable other than the PCIe link. In other embodiments, the serial COM port coupling may be emulated over PCIe, etc.

Further, the on-board storage of network interface 206 may be directly exposed to host 202 as a virtual storage resource. For example, the on-board storage may appear as an emulated Non-Volatile Memory Express (NVMe) storage device that may be exposed to host 202 via the PCIe link in some embodiments.

Information handling system 202 may also include a management controller 212 such as a BMC, which may be communicatively coupled to network interface 206, as well as other components in various embodiments.

As discussed above, embodiments of this disclosure may leverage a SmartNIC to provide advantages when analyzing a crash. As shown, network interface 206 may be communicatively coupled to administrator system 260 via its standard network link (e.g., via an in-band data network or via an out-of-band management network), allowing an administrator to access network interface 206 and/or other components of information handling system 200.

In some embodiments, host 202 may be configured to store core dump files at the on-board storage of network interface 206 via the emulated PCIe NVMe link. For example, a setting in the OS or application executing on host 202 may be set to designate the emulated NVMe device as the location where core dump files are to be stored. In this way, the core dump files may be available for analysis (e.g., from the administrator system 260) without the need to reboot host 202, which would destroy some of the information regarding the failed environment stored in the state of host 202.

When an error occurs in code executing on host 202, one or more core dump files may be stored in the on-board storage of network interface 206. Additionally, network interface 206 may collect logs of host 202 (e.g., before, during, and/or after the crash) via the serial COM port. Such logs may also be stored in the on-board storage of network interface 206 in some embodiments.

Still further, screenshots may be collected from host 202 (e.g., before, during, and/or after the crash). In one embodiment, this may be implemented via management controller 212. Management controller 212 may be communicatively coupled to host 202 and may interact with host 202 via management interfaces such as Redfish® and/or virtual network computing (VNC) and/or any other screen-sharing protocol to retrieve screenshots. Screenshots may be retrieved periodically in some embodiments, or in response to a crash in other embodiments. The screenshots may then be transmitted to network interface 206 (e.g., via a network controller sideband interface (NC-SI) communications channel. The screenshots may then be stored in the on-board storage of network interface 206.

In some embodiments, administrator system 260 may leverage the serial COM port coupled between network interface 206 and host 202 to perform interactive debugging of the live system. That is, in addition to transmitting logs from host 202 to network interface 206, the serial COM port may also provide bidirectional communications to allow a remote debugger (e.g., a kernel debugger or a user-mode debugger) to be attached to host 202 from administrator system 260.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a host information handling system comprising at least one host processor; and
a network interface that includes an on-board storage;
wherein the network interface is configured to enable remote debugging of a crash associated with the host information handling system by:
exposing the on-board storage to the host information handling system as a virtual storage resource;
receiving, from the host information handling system, a core dump file associated with the crash; and
allowing access to the core dump file from a remote information handling system.

2. The information handling system of claim 1, wherein the network interface is further configured to store at least one screenshot from the host information handling system in the on-board storage of the network interface.

3. The information handling system of claim 2, wherein the information handling system further comprises a management controller configured to provide out-of-band management of the information handling system, and further configured to:
receive the at least one screenshot from the host information handling system; and
transmit the at least one screenshot to the network interface.

4. The information handling system of claim 3, wherein the management controller is a baseboard management controller (BMC).

5. The information handling system of claim 4, wherein the BMC is communicatively coupled to the network interface via a network controller sideband interface (NC-SI) communications channel, and wherein the BMC is configured to receive the at least one screenshot via a virtual network computing (VNC) interface with the host information handling system.

6. The information handling system of claim 1, wherein the receiving the core dump file and the allowing access to the core dump file are configured to occur without an intervening reboot of the host information handling system.

7. A method comprising, in an information handling system that includes a host information handling system and a network interface that includes an on-board storage:
the network interface enabling remote debugging of a crash associated with the host information handling system by:
exposing the on-board storage to the host information handling system as a virtual storage resource;
receiving, from the host information handling system, a core dump file associated with the crash; and
allowing access to the core dump file from a remote information handling system.

8. The method of claim 7, further comprising:
the network interface storing at least one screenshot from the host information handling system in the on-board storage of the network interface.

9. The method of claim 8, wherein the information handling system further comprises a management controller configured to provide out-of-band management of the information handling system, the method further comprising:
the management controller receiving the at least one screenshot from the host information handling system; and
the management controller transmitting the at least one screenshot to the network interface.

10. The method of claim 9, wherein the management controller is a baseboard management controller (BMC).

11. The method of claim 10, wherein the BMC is communicatively coupled to the network interface via a network controller sideband interface (NC-SI) communications channel, and wherein the BMC is configured to receive the at least one screenshot via a virtual network computing (VNC) interface with the host information handling system.

12. The method of claim 7, wherein the receiving the core dump file and the allowing access to the core dump file are configured to occur without an intervening reboot of the host information handling system.

13. An article of manufacture comprising a non-transitory, computer-readable medium having instructions thereon that are executable by a processor of an information handling system including a host information handling system and a network interface that includes an on-board storage for:
the network interface enabling remote debugging of a crash associated with the host information handling system by:
exposing the on-board storage to the host information handling system as a virtual storage resource;
receiving, from the host information handling system, a core dump file associated with the crash; and
allowing access to the core dump file from a remote information handling system.

14. The article of claim 13, wherein the network interface is further configured to store at least one screenshot from the host information handling system in the on-board storage of the network interface.

15. The article of claim 14, wherein the information handling system further comprises a management controller configured to provide out-of-band management of the information handling system, and further configured to:
receive the at least one screenshot from the host information handling system; and
transmit the at least one screenshot to the network interface.

16. The article of claim 15, wherein the management controller is a baseboard management controller (BMC).

17. The article of claim 16, wherein the BMC is communicatively coupled to the network interface via a network controller sideband interface (NC-SI) communications channel, and wherein the BMC is configured to receive the at least one screenshot via a virtual network computing (VNC) interface with the host information handling system.

18. The article of claim 13, wherein the receiving the core dump file and the allowing access to the core dump file are configured to occur without an intervening reboot of the host information handling system.
